(19) United States
(12) Patent Application Publication
(10) Pub. No.: US 2026/0197473 A1
(43) Pub. Date: Jul. 9, 2026

(54) PROGRESSIVE GROWING VARIATIONAL AUTOENCODER TO BOOST TEMPORAL COMPRESSION

(71) Applicant: Adobe Inc., San Jose, CA (US)

(72) Inventors: Long Mai, San Jose, CA (US); Aniruddha Mahapatra, San Jose, CA (US); David Bourgin, San Jose, CA (US); Feng Liu, San Jose, CA (US)

(73) Assignee: Adobe Inc., San Jose, CA (US)

(21) Appl. No.: 19/015,278

(22) Filed: Jan. 9, 2025

(51) Int. Cl. H04N 19/31; H04N 19/436

(52) U.S. Cl. CPC H04N 19/31; H04N 19/436

(57) ABSTRACT

Embodiments are disclosed for using a progressive growing variational autoencoder to boost temporal compression. The method may include receiving a request to compress an input video. The method further includes providing the input video to a progressive encoder. The progressive encoder includes a top pipeline and a bottom pipeline. The method further includes generating, by the progressive encoder, a temporally compressed representation of the input video using a first latent space representation determined by the top pipeline and a second latent space representation determined by the bottom pipeline.

### BACKGROUND

Video compression is a technique used to reduce the size of a video. Compressing videos is useful for many applications including video storage, retrieval of similar (or dissimilar) videos, generating video content (e.g., extending frames of a video) and the like. Temporal compression is one method of video compression that is used to reduce the duration of a video, which can reduce the size of the video. For example, one method of temporal compression includes identifying frames of a video with redundant information and removing those redundant frames, reducing the duration of the video.

### SUMMARY

Introduced here are techniques/technologies that generate a high-quality temporally compressed representation of an input video. The generated high-quality temporally compressed representation can be decompressed, resulting in a high-quality reconstructed version of the input video. The reconstructed version of the input video is high-quality because it is perceived by a user to be visually similar to the input video.

More specifically, an encoder of a progressive growing variational autoencoder is used to generate the temporally compressed representation of the input video by gradually increasing the compression of the input video to achieve high-quality compression. The architecture of the encoder includes a top pipeline and a bottom pipeline, each generating a temporally compressed representation of the input video using gradual temporal compressions. The high-quality temporally compressed representation of the input video generated by the encoder is a combination of the temporally compressed representations determined by each pipeline of the encoder. The gradual compressions distributed across the multiple pipelines of the encoder result in the high-quality temporal compression of the input video. A decoder of the progressive growing variational autoencoder gradually increases the temporal decompression of the high-quality temporally compressed representation of the video to generate the high-quality reconstructed version of the input video.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of using a progressive growing variational autoencoder to boost temporal compression, in accordance with one or more embodiments;

FIG. 2 illustrates the progressive encoder architecture, in accordance with one or more embodiments;

FIG. 3 illustrates the progressive decoder architecture, in accordance with one or more embodiments;

FIG. 4 illustrates an example process of training the progressive growing VAE, in accordance with one or more embodiments;

FIG. 5 illustrates an example deployment of the progressive encoder and progressive decoder of the progressive growing VAE, in accordance with one or more embodiments;

FIG. 6 illustrates a schematic diagram of the system for progressive growing VAE in accordance with one or more embodiments;

FIG. 7 illustrates a flowchart of a series of acts in a method of using a progressive growing variational autoencoder to boost temporal compression in accordance with one or more embodiments; and

FIG. 8 illustrates a block diagram of an exemplary computing device in accordance with one or more embodiments.

### DETAILED DESCRIPTION

One or more embodiments of the present disclosure include a progressive growing variational autoencoder with a multi-pipeline encoder that gradually compresses an input video in time across each pipeline of the multi-pipeline encoder. The progressive growing variational autoencoder includes a decoder that gradually decompresses a temporally compressed representation of the input video. In one conventional approach, video temporal compression is obtained by extending the variational autoencoder architecture with additional layers. For example, the encoder of the variational autoencoder is appended with additional temporal down-sampling layers and the decoder of the variational autoencoder is appended with additional temporal up-sampling layers. Other conventional approaches achieve temporal compression using a sequence of temporal compression layers or models. However, the addition of new layers decreases the quality of reconstruction. Additionally, the addition of new layers and models can require training the model from scratch to learn how to temporally compress an input video. Training a model from scratch requires time for training and a corpus of training data. In effect, the variational autoencoder of conventional systems is being trained to learn the challenging task of temporal compression in a single pass using the single sequence of layers and/or models in each of the encoder and decoder of the variational autoencoder. Such models end up learning temporal compression that degrade the quality of the input video by virtue of the complex single-pass compression task. For example, the degraded reconstruction of the input video can appear as the input video with compressed-out high action motion. Accordingly, using such conventional solutions, the reconstruction of the input video does not appear to visually match the input video.

To address these and other deficiencies in conventional systems, the variational autoencoder of the present disclosure includes a progressive encoder and progressive decoder that progressively grow temporal compression and decompression respectively. For example, earlier layers of the progressive encoder target lower compression ratios and later layers are trained to perform higher compression ratios. Further, the multi-pipeline architecture of the progressive encoder enables multi-pass temporal compression. The compression of the input video determined using each pass of temporal compression determined by each pipeline of the multi-pipeline architecture reduces information loss during the compression. As a result, the progressive encoder achieves higher temporal compression at high-quality with respect to the temporal compression achieved by conventional approaches.

The progressive encoder of the variational autoencoder leverages a pretrained encoder, simplifying the training of the progressive encoder by virtue of updating fewer parameters during training. As a result, the time and training data required to train the progressive encoder is reduced. Similarly, the progressive decoder of the variational autoencoder leverages a pretrained decoder that simplifies the training of the progressive decoder. As a result, the time and training data required to train the progressive decoder is reduced.

Improving the quality of the temporally compressed video reduces computing resources that would otherwise be consumed re-running conventional temporal compression models. By deploying the progressive growing variational autoencoder described herein to generate high-quality temporally compressed videos and high-quality video reconstructions, software resources are not consumed fixing or otherwise adjusting low-quality or otherwise inaccurate video reconstructions generated by conventional systems. As a result, power, bandwidth, and other computing resources are conserved.

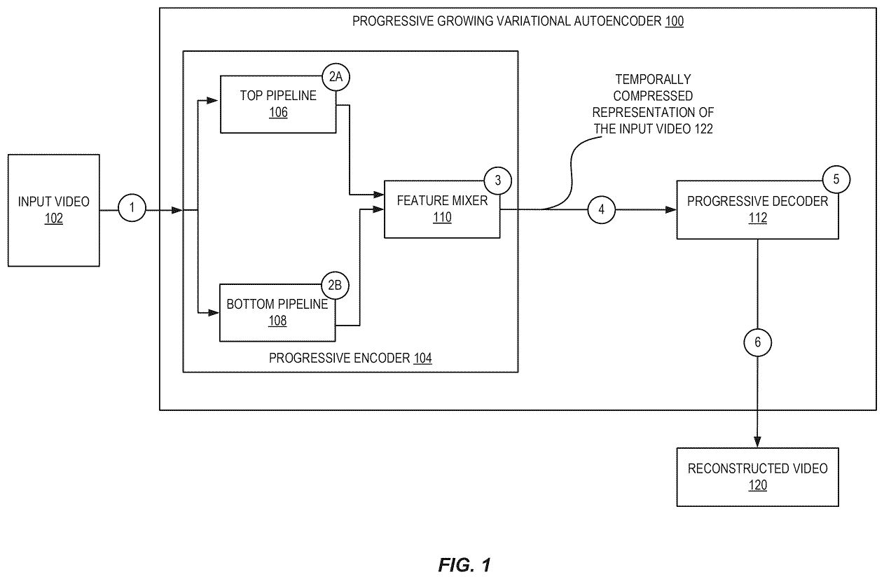

FIG. 1 illustrates a diagram of a process of using a progressive growing variational autoencoder to boost temporal compression, in accordance with one or more embodiments. As shown in FIG. 1, a progressive growing variational autoencoder (VAE) 100 can generate a temporally compressed representation of an input video 122 and decompress the temporally compressed representation of the input video to obtain a high-quality reconstruction of the input video 120. The reconstruction of the input video 120 is high-quality because it is perceived by a user to be visually similar to the input video 102. For example, the content of the reconstructed input video 120 is similar to that of the content in the input video 102, the movement and speed of content of the reconstructed input video 120 is similar to that of the movement and speed of the content in the input video 102, etc. A low-quality reconstruction of the input video would omit content in the input video 102 (e.g., content of the input video is compressed out of the low-quality reconstruction of the input video). Additionally, the movement and speed of the content in the low-quality reconstruction of the input video could be choppy, disconnected, fragmented, etc.

The progressive growing VAE 100 includes a progressive encoder 104 and a progressive decoder 112. The progressive growing VAE 100 can be implemented as a standalone system such as an application executing on a client computing device, server computing device, or other computing device. In some embodiments, the progressive growing VAE 100 may be implemented as a tool incorporated into another system, service, application, etc. to temporally compress a video to obtain a temporally compressed representation of the input video 122 and/or decompress a temporally compressed video to obtain the reconstructed version of the video 120. The progressive growing VAE 100 may be implemented in a user device, in a service provider device as part of a cloud computing model, or other device which may receive videos and/or return videos.

At numeral 1, the progressive growing VAE 100 receives input video 102. The input video 102 includes a number of frames of a video. The input video 102 is a sequence of frames that, when presented to a user, visually cause objects in the frames to appear in motion. The frames of the input video 102 are passed to the progressive encoder 104 of the progressive growing VAE 100.

The progressive encoder 104 is a neural network configured to encode data, transforming data of a first format (e.g., frames of the input video 102) into a second format (e.g., a numerical representation of the input video 102 or a latent space representation of the input video). The latent space representation of the input video is the temporally compressed input video. In other words, the latent space representation of the input video is the temporally compressed representation of the input video 122. It should be appreciated that while temporal compression is described herein, the latent space representation of the input video is also spatially compressed. For example, one or more models used to generate the temporally compressed representation of the input video 122 can spatially compress the input video 102. Latent space is a multi-dimensional abstract space in which unobserved features are determined such that relationships and other dependencies of such features can be learned.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

At numeral 2A, a top pipeline 106 of the progressive growing VAE 100 generates a top pipeline temporally compressed representation of the input video 102. The top pipeline 106 includes a first model to temporally compress the input video 102 to a first compression ratio. That is, the first model generates a first temporally compressed representation of the input video 102. In some embodiments, the first model compresses the input video 102 by dropping one or more frames. The top pipeline 106 also includes a second model to temporally compress the first temporally compressed representation of the input video, resulting in a second temporally compressed representation of the input video. In some embodiments, the second model compresses the first temporally compressed representation of the input video at a second compression ratio that is the same as, or higher than, the first compression ratio. For example, the first compression ratio is 2:1 and the second compression ratio is 4:1. A higher compression ratio corresponds to more information in the input video 102 being compressed-out. As a result, the size of the input video decreases. In some embodiments, the second model compresses the first temporally compressed representation of the input video at a compression ratio that is lower than the first compression ratio. The subsequent compression of the first temporally compressed representation of the input video by the second model corresponds to the gradual compression of the top pipeline. The second temporally compressed representation of the input video corresponds to the top pipeline 106 temporally compressed representation of the input video.

At numeral 2B, the bottom pipeline 108 of the progressive growing VAE generates a bottom pipeline temporally compressed representation of the input video 102. The bottom pipeline 108 includes a model to temporally compress the input video 102 to a first compression ratio. That is, the model generates a first temporally compressed representation of the input video 102. In some embodiments, the model used to generate the first temporally compressed representation of the input video 102 is the same as the second model used to generate the second temporally compressed representation of the input video in the top pipeline 106. The bottom pipeline 108 also includes a specialized model to temporally compress the first temporally compressed representation of the input video, resulting in a second temporally compressed representation of the input video. The specialized model is configured to mitigate information loss associated with any over compression performed by the top pipeline 106. The second temporally compressed representation of the input video corresponds to the bottom pipeline 108 temporally compressed representation of the input video.

At numeral 3, the feature mixer 110 receives the top pipeline temporally compressed representation of the input video determined by the top pipeline and the bottom pipeline temporally compressed representation of the input video determined by the bottom pipeline. The feature mixer 110 combines the temporally compressed representations of each pipeline of the progressive encoder to generate the temporally compressed representation of the input video 122.

At numeral 4, the temporally compressed representation of the input video 122 is passed to the progressive decoder 112. However, it should be appreciated that the temporally compressed representation of the input video 122 may be passed to other components, applications, or services external to the progressive growing VAE 100. In this manner, other components, applications or services external to the progressive growing VAE 100 can perform operations on, or otherwise use, the temporally compressed representation of the input video 122. For example, one or more downstream applications can benefit from a temporally compressed representation of an input video 122. In a non-limiting example, using the temporally compressed representation of the input video 122, video diffusion models can increase the duration of the input video 102, add new content of the input video 102, generate a new video based on the input video 102, and the like.

At numeral 5, the progressive decoder 112 receives the temporally compressed representation of the input video 122. As shown in FIG. 1, the progressive decoder 112 receives the temporally compressed representation of the input video 122 from the progressive encoder 104. However, as described herein, the progressive decoder 112 can receive the temporally compressed representation of the input video 122 (or a modified version of the temporally compressed representation of the input video 122, depending on the one or more applications that use the temporally compressed representation of the input video 122) from one or more components external to the progressive growing VAE 100.

The progressive decoder 112 generates the reconstructed video 120 by gradually decompressing the temporally compressed representation of the input video 122. For example, the progressive decoder 112 includes a first model to temporally decompress the temporally compressed representation of the input video 122 at a first decompression ratio. That is, the first model generates a first temporally decompressed representation of temporally compressed representation of the input video 122. The progressive decoder 112 also includes a second model to temporally decompress the first temporally decompressed representation, resulting in a second temporally decompressed representation of the temporally compressed representation of the input video 122. The second model decompresses the first temporally decompressed representation of a second decompression ratio. In some embodiments, the second decompression ratio is dependent on the second decompression ratio of the second model in the top pipeline 106. That is, the decompression performed by the second model of the progressive decoder 112 decompresses to the extent that the second model in the top pipeline 106 compressed the first temporal compression of the input video.

At numeral 6, the reconstructed video 120 is presented to a user or passed to one or more downstream applications. The reconstructed video 120 determined by the progressive decoder 112 is high-quality in that it is perceived by a user as an accurate representation of the input video 102. For example, the content of the reconstructed video 120 visually matches the content of the input video 102. In some embodiments, the reconstructed video 120 is a reconstructed version of the input video 102. For example, if one or more downstream applications generate content for the input video 102 using the temporally compressed representation of the input video 122, then the reconstructed video 120 is the version of the reconstructed video with the generated content.

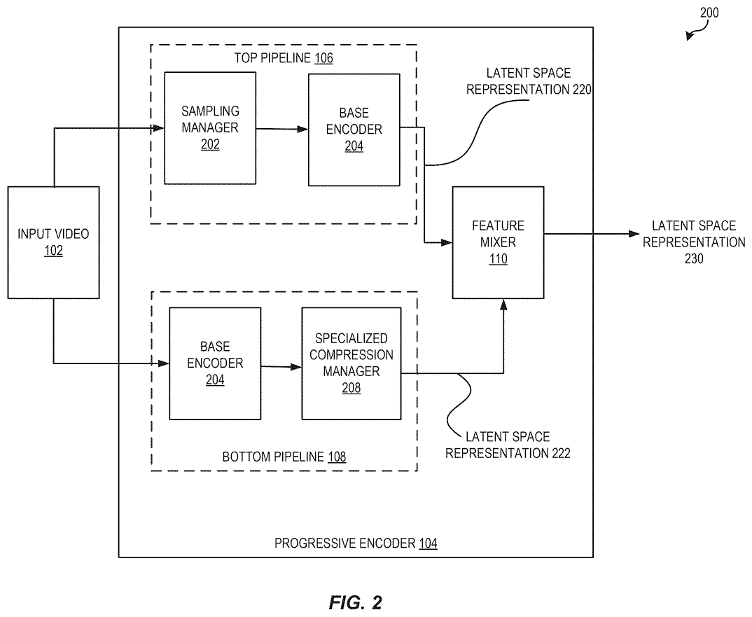

FIG. 2 illustrates the progressive encoder architecture, in accordance with one or more embodiments. As shown in example 200, frames of the input video 102 are passed to both the top pipeline 106 and the bottom pipeline 108 of the progressive encoder 104.

In the top pipeline 106, the sampling manager 202 can be any model configured to perform a first temporal compression of the input video 102. In some embodiments, the sampling manager 202 can sample every other frame of the N frames of the input video 102 to temporally compress the input video to N/2 frames. The first temporally compressed representation of the input video (e.g., the sub-sampled frames) are passed to the base encoder 204.

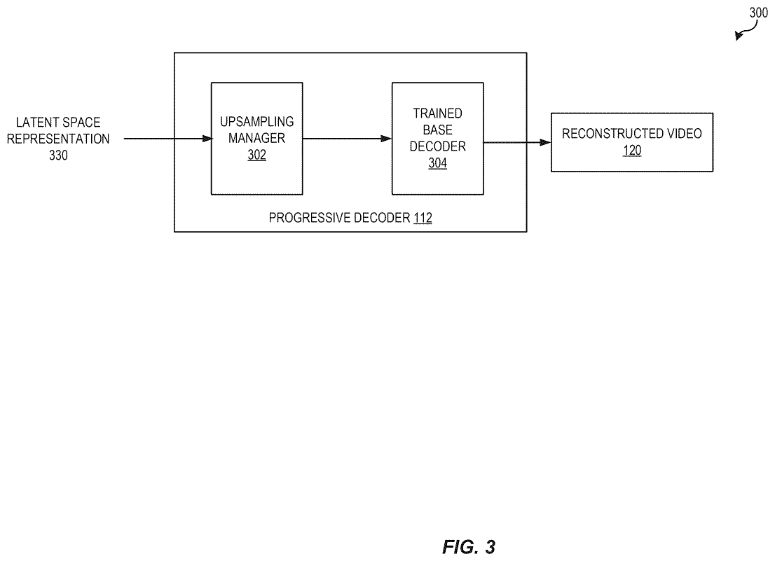

The base encoder 204 can be any encoder configured to temporally compress the subsampled frames. For example, the base encoder 204 can be any out of the box or generic encoder of a VAE that is trained to compress a video by a factor of four. Because the base encoder 204 is included as part of a VAE, a corresponding base decoder (e.g., base decoder described in FIG. 3) is trained to decompress the 4x temporal compression performed by the base encoder 204.

In some embodiments, the base encoder 204 is configured to compress the sub-sampled representation of the input video 102 using convolutional layers to further down-sample the sub-sampled representation of the input video 102 (e.g., the first temporally compressed representation of the input video 102). The convolutional layer(s) of the base encoder 204 convolve one or more frames of the sub-sampled representation of the input video 102 with one or more filters to extract features of the frame(s), creating the latent space representation. Further down sampling can be achieved using additional convolutional layers (e.g., strided convolution) and/or pooling layers. For example, pooling layer can apply a pooling window to the latent space representation. The pooling layer may be a max pooling layer (or any other type of pooling later) that detects prominent features. In some configurations, the pooling layer may be an average pooling layer. The pooling layer(s) reduce the dimensionality of the latent space representation to further down-sample the latent space representation. As described herein, the latent space representation 220 determined by the base encoder 204 is a numerical representation of the temporally compressed input video in a vector or tensor.

In a non-limiting example, N frames of the input video 102 sampled by a factor of two from the sampling manager 202 is used to obtain N/2 frames of the input video 102. The sub-sampled representation of the input video (e.g., the first temporally compressed representation of the input video) is further compressed by a factor of four given a base encoder configured with a compression ratio of four. As a result, the N frames of the input video are temporally compressed to N/8 frames at the output of the base encoder 204. The output of the base encoder 204 is the latent space representation 220 that numerically represents the input video compressed by a factor of eight. The latent space representation 220 determined by the top pipeline 106 is a first pass of temporal compression of the input video, or K times temporal compression of the input video.

In the bottom pipeline 108, the base encoder 204 temporally compresses the frames of the input video 102. For example, given the base encoder 204 described with reference to the top pipeline 106 that has a compression ratio of four, the N frames of the input video 102 would be represented numerically as a latent space representation of N/4 frames of the input video 102.

The specialized compression manager 208 includes a number of layers (or one or more blocks of layers) configured to further temporally compress the first temporal compression determined by the base encoder 204. In some embodiments, the specialized compression manager 208 is a ResNet block. In a non-limiting example, given the latent space representation of N/4 frames of the input video 102 determined by the base encoder 204 of the bottom pipeline 108, the specialized compression manager 208 can perform an addition temporal compression with a compression ratio of two such that the output of the specialized compression manager 208 is a latent space representation of N/8 frames of the input video 102 (e.g., latent space representation 222).

As described herein, the specialized compression manager 208 is trained to learn residual temporal compression information associated with the top pipeline 106. In other words, information that would be lost by performing the first pass of compression using the top pipeline 106 is captured by the specialized compression manager 208. As a result, the latent space representation 230 generated by the combination of the top pipeline latent space representation 220 and the bottom pipeline latent space representation 222 minimizes compression information loss, resulting in a high-quality temporal compression of the input video 102. The latent space representation 222 determined by the bottom pipeline 108 is a second pass of temporal compression of the input video or K times temporal compression of the input video.

The feature mixer 110 algorithmically combines the latent space representation 220 determined by the top pipeline 106 and the latent space representation 222 determined by the bottom pipeline 108 to generate latent space representation 230. For example, the feature mixer 110 adds the latent space representation 220 to the latent space representation 222. The feature mixer 110 is able to combine the latent space representations determined by each pipeline by virtue of the dimension of the latent space representation from each pipeline being the same. That is, each pipeline temporally compresses the input video 102 by the same compression ratio (e.g., N/8).

In example 200, one top pipeline and one bottom pipeline are depicted in the progressive encoder 104. However, it should be appreciated the multiple top pipelines and corresponding bottom pipelines can be deployed to further temporally compress the input video 102. Each top pipeline and corresponding bottom pipeline generate a latent space representation that is combined using the feature mixer 110. In operation, each of the bottom pipelines are trained in an end-to-end manner to learn residual temporal compression information (e.g., information loss) associated with the corresponding multiple top pipelines. In some embodiments, multiple progressive encoders are deployed in sequence to further temporally compress an input video 102.

In example 200, both the top pipeline and the bottom pipeline include two models used for temporal compression (e.g., the sampling manager 202 and the base encoder 204, and the base encoder 204 and the specialized compression manager 208 respectively). However, it should be appreciated that the top pipeline and the bottom pipeline can include more than two models, where each model in the pipelines further compresses a temporally compressed representation of the input video. In this manner, gradual compression of the input video 102 is achieved using each of the models of the respective pipeline.

FIG. 3 illustrates the progressive decoder architecture, in accordance with one or more embodiments. As shown in example 300, latent space representation 330 is passed to the progressive decoder 112. In some embodiments, latent space representation 330 is the same as latent space representation 230 determined by the progressive encoder 104 described in FIG. 2. In some embodiments, the latent space representation 330 is a modified latent space representation 230 determined by the progressive encoder 104 described in FIG. 2. For example, one or more applications or services can modify the latent space representation 230 determined by the progressive encoder 104 described in FIG. 2 to obtain a modified latent space representation (e.g., latent space representation 330).

The progressive decoder 112 includes an upsampling manager 302 that is configured to up-sample the latent space representation 330. In operation, the upsampling manager 302 generates a temporally decompressed representation of the temporally compressed representation of the input video (e.g., the latent space representation 330). The upsampling manager 302 is a model configured to use any one or more upsampling techniques to interpolate data in the latent space representation 330, increasing the dimension of the latent space representation 330. An example method of interpolation is zero padding the latent space representation 330 to increase the dimension of the latent space representation 330. Subsequently, the zero padded latent space representation is passed through a filter (such as a lowpass filter) to smooth discrepancies in the zero padded latent space representation.

The upsampling performed by the upsampling manager 302 is dependent on the degree of decompression performed by the trained base decoder 304. The trained base decoder is a trained version of a base decoder associated with the base encoder 204 described in FIG. 2. As described herein, the base encoder 204 and base decoder are encoders and decoders of an autoencoder. If the base encoder 204 described in FIG. 2 compresses by a factor of four, the trained base decoder 304 decompresses by a factor of four by virtue of the base encoder 204 and trained base decoder 304 being associated with the same autoencoder. If the latent space representation 330 is a representation of the input video compressed by a factor of 8 (e.g., a numerical representation of N/8 frames of an input video, as described in the example of FIG. 2) and the trained base decoder 304 decompresses by a factor of four (in the above example), then the upsampling manager 302 up-samples the latent space representation 330 by a factor of two such that the reconstructed video 120 is decompressed (e.g., N frames). That is, the N/8 frame latent space representation 330 is decompressed to a N/4 latent space representation by the upsampling manager 302 and further decompressed to an N frame reconstructed video 120 by the trained base decoder 304.

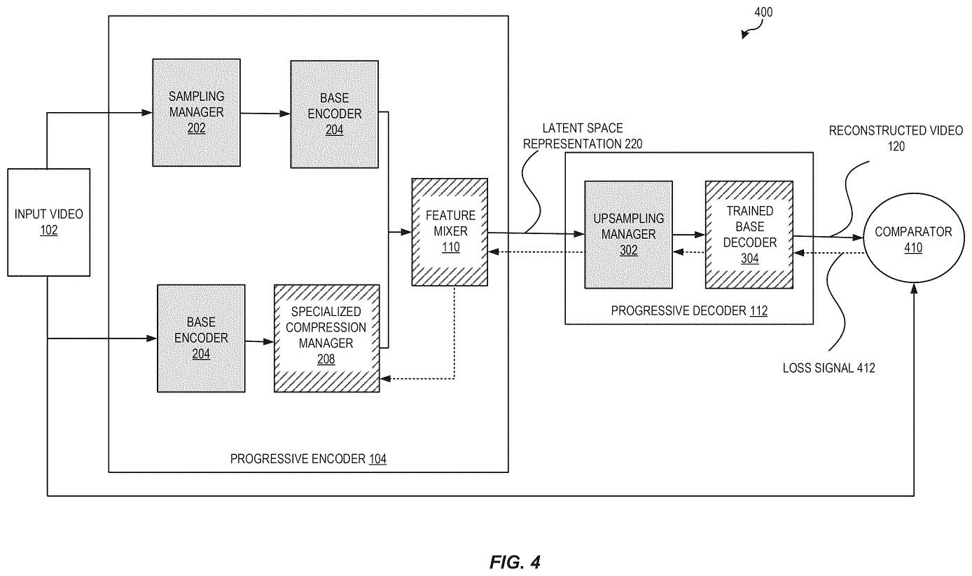

The trained base decoder 304 is a fine-tuned or trained version of the base decoder associated with the base encoder 204 described in FIG. 2. Fine-tuning is the process of adjusting the parameters of a machine learning model that has been previously trained to perform a task. As described herein, the base encoder 204 and base decoder are part of an autoencoder configured to compress and decompress a video. The base decoder is fine-tuned such that it becomes trained base decoder 304 by virtue of adjusting the weights (or other parameters) of the base decoder during training of the progressive decoder 112. Training the progressive decoder 112 in an end-to-end manner is described in FIG. 4.

The trained base decoder 304 decompresses the up-sampled latent space representation determined by the upsampling manager 302 (e.g., the temporally decompressed representation of the temporally compressed representation of the input video), resulting in reconstructed video 120. The reconstructed video 120 is perceived by a user to visually match the input video 102 by virtue of the high-quality latent space representation 330.

FIG. 4 illustrates an example process of training the progressive growing VAE, in accordance with one or more embodiments. Training the progressive growing VAE is the same as training the progressive encoder 104 and the progressive decoder 112 end-to-end. The autoencoder is trained using self-supervised learning (or unsupervised learning) using frames of an input video.

As described herein, the reconstructed video 120 determined by the progressive decoder 112 is high quality if the reconstructed video 120 is perceived by a user to appear visually similar to the input video 102. The reconstruction of the input video 102 is dependent on the quality of compression performed by the progressive encoder 104. During end-to-end training, the output of the progressive encoder 104 is passed as the input to the progressive decoder 112 such that the comparator 410 can evaluate the differences between the reconstructed video 120 and the input video 102.

The flow of data passing through the each of the components of the progressive encoder 104 (e.g., sampling manager 202, base encoder 204, specialized compression manager 208, and feature mixer 110) and progressive decoder 112 (e.g., upsampling manager 302 and trained base decoder 304) is illustrated as solid black arrows. The description of each of the components of the progressive encoder 104 operating in accordance with the flow of data is described in FIG. 2. Similarly, the description of each of the components of the progressive decoder 112 operating in accordance with the flow of data is described in FIG. 3.

In operation, one or more nodes of a layer of a machine learning model (e.g., the base encoder 204, the specialized compression manager 208, and the trained base decoder 304) are applied to an input (e.g., input video 102 and decompressed representation of the latent space representation 220). A layer can refer to a sub-structure of a machine learning model and includes a number of nodes (e.g., neurons) that perform a particular computation and are interconnected to nodes of adjacent layers. Nodes can be used to sum values from adjacent nodes and apply an activation function, allowing the layer to detect nonlinear patterns. Nodes are interconnected by weights, which are adjusted based on an error determined by the comparator 410. The adjustment of the weights during training facilitates the machine learning model's (e.g., the base encoder 204, the specialized compression manager 208, and the trained base decoder 304) ability to determine an output (e.g., the temporally compressed representation of the input video such as latent space representation 220 and the reconstructed video 120 respectively).

The comparator 410 can evaluate the difference between the reconstructed video 120 determined by the progressive decoder 112 and the input video 102 using any one or more evaluation techniques. For example, the comparator 410 can evaluate the difference between the reconstructed video 120 and the input video 102 using one or more loss functions such as the mean squared error loss (e.g., an evaluation of each pixel of the reconstructed video 120 with respect to each corresponding pixel of the input video 102), perceptual loss (LPIPS loss) (e.g., an evaluation of one or more features of the reconstructed video 120 with respect to one or more features of the input video 102), and generative adversarial network (GAN) loss (e.g., a minmax loss based on minimizing the loss of the reconstructed video 120 and the input video 102 and maximizing the loss of a discriminator machine learning model classifying the reconstructed video 120). The one or more losses determined from the one or more loss functions are algorithmically combined by the comparator 410 as loss signal 412.

The progressive encoder 104 and progressive decoder 112 are trained end-to-end using the backpropagation algorithm. The backpropagation algorithm operates by propagating the loss signal 412 through the components of the progressive encoder 104 and progressive decoder 112, illustrated by the dashed arrows. Some components of the progressive encoder 104 and progressive decoder 112 are not trained, as illustrated by grey boxes (e.g., sampling manager 202, base encoder 204, and upsampling manager 302). Such components can be used to propagate the loss signal 412, but the parameters of such components are not updated during the training method 400. The components of the progressive encoder 104 and progressive decoder 112 that are trained during the training method 400 are illustrated using hatch patterns (e.g., trained base decoder 304, feature mixer 110, and specialized compression manager 208).

A component trained in the progressive decoder 112 is the trained base decoder 304. As described herein, any pretrained autoencoder configured to perform temporal compression on a video and including an encoder and decoder can be used for the base encoder 204 and base decoder respectively. The pretrained autoencoder includes a base decoder that is configured to decompress the latent space representation determined by the base encoder. The base decoder of the autoencoder is trained during the end-to-end training method 400 because the base decoder is not simply receiving the latent space representation determined by the base encoder. That is, the training used to train the base decoder with respect to the base encoder of the autoencoder does not directly apply to the progressive decoder 112 with respect to the progressive encoder 104. For example, the trained base decoder 304 receives the temporally decompressed representation of the temporally compressed representation of the input video (e.g., the latent space representation determined using a progressive encoder 104 and up-sampled by the upsampling manager 302). The base decoder of the autoencoder is updated during the end-to-end training method 400 to correspond to the input of the base decoder. As a result, the reconstruction performed by the trained base decoder 304 is based on the latent space representation 220 received from the progressive encoder 104 (and not the latent space representation received from a base encoder).

In some embodiments, the trained base decoder 304 is initialized with the weights of the base decoder associated with the base encoder 204. Over a number of training iterations, the weights of the trained base decoder 304 are updated using the loss signal 412 such that the base decoder becomes the trained base decoder 304. In some embodiments, a trainable layer is added to the base decoder. In these embodiments, weights of the trainable layer are adjusted to modify the output of the base decoder. In this manner, the weights of the base decoder are not updated, but the trainable layer appended to the base decoder is updated such that the base decoder becomes the trained base decoder 304.

A component trained in the progressive encoder 104 is the feature mixer 110. For example, one or more hyperparameters such as weighting coefficients of the feature mixer 110 can be tuned during training (e.g., based on the loss signal 412) to adjust how the top pipeline latent space representation is combined with the bottom pipeline latent space representation.

As described herein, the components in both the top pipeline (e.g., sampling manager 202 and base encoder 204) and the bottom pipeline (e.g., base encoder 204 and specialized compression manager 208) are used to generate the latent space representation of the input video that is used to determine the reconstructed video 120. However, the only component trained in the progressive encoder 104 is the specialized compression manager 208 in the bottom pipeline. In operation, the method 400 skips training the top pipeline of the progressive encoder using the loss signal 412.

As shown by the solid arrows in the progressive encoder 104, the specialized compression manager 208 in the bottom pipeline does not receive any information from the top pipeline. In contrast, as indicated by the dashed arrows, the specialized compression manager 208 in the bottom pipeline receives the loss signal 412 based on the reconstructed video 120. As a result, the specialized compression manager 208 is adjusted based on the information lost during the first pass of compression determined by the top pipeline of the progressive encoder.

In operation, the quality of the latent space representation 220 depends on the quality of the reconstructed video 120. In other words, if the reconstructed video 120 is low quality (e.g., does not appear to visually match the input video 102), then the latent space representation 220 is low quality by virtue of the reconstructed video's 120 dependence on the latent space representation 220. The latent space representation 220 is low quality if the progressive encoder 104 over compresses. That is, too much information is compressed out of the input video 102 making the latent space representation 220 low quality. The specialized compression manager 208 can improve the quality of the latent space representation 220 by learning to implicitly identify the information of the input video 102 that is compressed out by the top pipeline and correcting the over compression using the loss signal 412. In other words, the compression in the top pipeline of the progressive encoder 104 guides the compression in the bottom pipeline of the progressive encoder 104. If the top pipeline of the progressive encoder 104 did not exist (such as is the architecture of some conventional encoders), then during the end-to-end training of method 400, one or more components of the encoder would adjust to improve the quality of the entire compression resulting in the latent space representation 220. The multi-pipeline approach to the progressive encoder 104 simplifies the training task from adjusting the components of the pipeline to learn the latent space representation 220 to skipping training in a portion of the progressive encoder 104 and performing training in another portion of the progressive encoder 104 such that the specialized compression manager 208 to learns an over compression of the top pipeline. That is, the specialized compression manager 208 is not being trained to generate the latent space representation 220 but is instead being trained to learn the over compression of the top pipeline (e.g., the first pass of temporally compression determined by the top pipeline of the progressive encoder 104).

After a number of training iterations, the progressive encoder 104 and progressive decoder 112 generate a reconstructed video 120 that converges to the input video 102. The progressive growing VAE (e.g., the progressive encoder 104 and the progressive decoder 112) may be trained until the loss determined at the comparator 410 is within a certain threshold, or a threshold number of batches, epochs, or training iterations has been reached.

It should be appreciated that the base encoder 204 and the trained base decoder 304 are described as encoders and decoders of a trained autoencoder. However, it should be appreciated that the training method 400 can be used to train the base encoder 204 and the trained base decoder 304. For example, in some embodiments, the base encoder 204 and trained base decoder 304 are trained with the feature mixer 110 and specialized compression manager 208 as shown in training method 400. For example, the loss signal 412 propagates through trained base decoder 304, upsampling manager 302 (but does not train the upsampling manager 302 as shown in FIG. 4), feature mixer 110, base encoder 204, and specialized compression manager 208. In some embodiments, the base encoder 204 and trained base decoder 304 are trained as encoders and decoders of the progressive encoder 104 and progressive decoder 112 respectively. Accordingly, the loss signal 412 propagates through the trained base decoder 304 and base encoder 204.

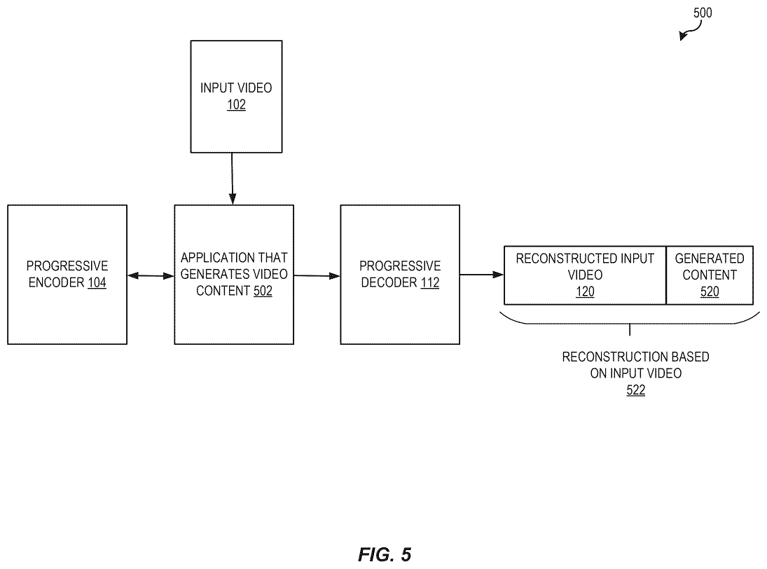

FIG. 5 illustrates an example deployment of the progressive encoder and progressive decoder of the progressive growing VAE, in accordance with one or more embodiments. In example 500, a user directs an input video 102 to an application that generates video content 502. For example, the user can upload the input video 102 to the application that generates video content 502 or provide an address location (e.g., a URL) of the input video 102 to the application that generates video content 502. The user can provide the application that generates video content 502 with additional information such as content to be added in the generated video and/or a duration of a video extension of the input video 102.

The application that generates video content 502 can include any one or more generative machine learning models that are configured to generate video content. For example, in some embodiments, the application that generates video content 502 generates frames of the input video 102 to extend the duration of the input video 102.

The application that generates video content 502 transmits a request (including the input video 102) to the progressive encoder 104 to temporally compress the input video 102. The progressive encoder returns, to the application that generates video content 502, a temporally compressed representation of the input video 102 (e.g., a vector or tensor including a latent space representation of the input video).

The application that generates video content 502 performs one or more video content generation processes. During processing of the temporally compressed representation of the input video, the temporally compressed representation of the input video is modified. In operation, the values of the vector including the latent space representation of the input video are modified such that the temporally compressed representation of the input video encodes content generated by the application that generates video content 502. For example, the application that generates video content 502 generates additional frames of the input video 102 to extend the duration of the input video 102. The generation of the additional frames are encoded in the latent space representation of the input video. In some embodiments, the latent space representation of the input video 102 is preserved and the content generated by the application that generates video content 502 is passed as an additional input to the progressive decoder 112.

The modified temporally compressed representation of the input video is passed to the progressive decoder 112 for decompression. In the example described herein, if the application that generates video content 502 generates additional frames of the video, then the progressive decoder 112 reconstructs input video 102 and appends the generated additional frames to the reconstructed input video (e.g., generated content 520). As a result, the progressive decoder 112 generates a reconstruction based on the input video 522. In some embodiments, the reconstruction based on the input video 522 can include content that does not exist in the input video 102 (e.g., in the case of an application that generates new video content using the input video 102). The reconstructed input video 120 and generated content 520 can be presented to the user using a user interface of a client device.

It should be appreciated that any other application or service can be used as a replacement to, or an addition to, the application that generates video content 502. For example, the user can direct input video 102 to a storage service by saving or otherwise storing the input video 102. The storage service can call the progressive encoder 104 and progressive decoder 112 as described herein to store a temporally compressed representation of the input video (conserving resources such as memory and power) and subsequently obtain the reconstructed input video 120 by decompressing the temporally compressed representation of the input video responsive to a query from a user or other upstream application.

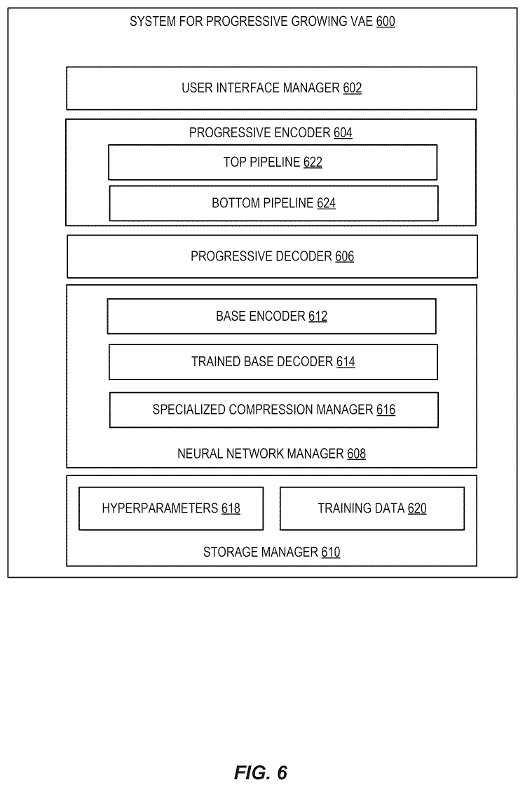

FIG. 6 illustrates a schematic diagram of the system for progressive growing VAE, in accordance with one or more embodiments. As shown, the system for progressive growing VAE 600 may include, but is not limited to, a user interface manager 602, a progressive encoder 604, a progressive decoder 606, a neural network manager 608, and a storage manager 610. The progressive encoder 604 includes a top pipeline 622 and a bottom pipeline 624. The neural network manager 608 includes a base encoder 612, a trained base encoder 614, and a specialized compression manager 616. The storage manager 610 includes hyperparameters 618 and training data 620.

As illustrated in FIG. 6, the system for progressive growing VAE includes a user interface manager 602. For example, the user interface manager 602 allows users to provide input videos (e.g., videos to be extended) to the system for progressive growing VAE 600. In some embodiments, the user interface manager 602 provides a user interface element through which the user can upload the input videos (or an input image). Alternatively, or additionally, the user interface may enable the user to download the videos/images from a local or remote storage location (e.g., by providing an address (e.g., a URL or other endpoint) associated with a video source or an image source). In some embodiments, the user interface can enable a user to link a capture device, such as a camera or other hardware to capture video data and/or image data, and provide the data to the system for progressive growing VAE 600.

Additionally, the user interface manager 602 provides access to a graphical user interface that includes one or more user interface elements. In some embodiments, a developer or administrator user can access the graphical user interface to evaluate the end-to-end training of the progressive growing VAE 100. For example, the loss determined by the comparator 410 can be displayed to the user (e.g., as a graph, for instance) over a number of training iterations. In some embodiments, the graphical user interface allows a user to view the input video and the reconstructed input video. As described herein, the reconstructed input video can be a reconstructed version of the input video including one or more modifications to the input video (e.g., content generated by one or more upstream services or applications).

As illustrated in FIG. 6, the system for progressive growing VAE 600 includes progressive encoder 604. The progressive encoder 604 generates a temporally compressed input video using a latent space representation of the input video.

The top pipeline 622 of the progressive encoder 604 generates a top-pipeline temporally compressed representation of the input video (e.g., a number of frames of a video). In operation, the top pipeline 622 includes a sequence of models that each perform a temporal compression on their respective inputs. For example, the top pipeline 622 includes a sampling manager (not shown) configured to perform a first temporal compression of the input video at a first compression ratio. The top pipeline 622 also includes the base encoder 612 configured to perform a second temporal compression using the first temporal compression of the input video. The compression performed by the base encoder 612 is at a second compression ratio that is greater than the first compression ratio. As described herein, the base encoder 612 can be a component of a pretrained autoencoder. In operation, each model of the top pipeline 622 generates a temporally compressed representation of the input video.

The bottom pipeline 624 of the progressive encoder 604 generates a bottom pipeline temporally compressed representation of the input video. The bottom pipeline temporally compressed representation of the input video is different from the top pipeline temporally compressed representation of the input video generated by the top pipeline 622.

In operation, the bottom pipeline 624 includes a sequence of models that each perform a temporal compression on their respective inputs. For example, the bottom pipeline 624 includes the base encoder 612 configured to perform a first temporal compression of the input video at the second compression ratio. The bottom pipeline 624 also includes the specialized compression manager 616 configured to perform a second temporal compression using the first temporal compression of the input video. The compression performed by the specialized compression manager 616 is guided by the compression performed by the top pipeline temporal compression generated by the top pipeline 622, by virtue of being trained in an end-to-end manner. For example, the specialized compression manager 616 performs temporal compression based on information loss in the top pipeline temporal compression. As a result, the temporal compression generated by the progressive encoder, combining the top pipeline temporal compression and the bottom pipeline temporal compression, corrects over compression performed in the top pipeline temporal compression. In operation, each model of the bottom pipeline 624 generates a temporally compressed representation of the input video.

As illustrated in FIG. 6, the system for progressive growing VAE 600 includes a progressive decoder 606. The progressive decoder 606 decompresses a temporally compressed representation of an input video. In some embodiments, the temporally compressed representation of the input video is the temporally compressed representation of the input video generated by the progressive encoder 604. As a result, the progressive decoder 606 generates a reconstructed input video. In some embodiments, the temporally compressed representation of the input video is a modified version of the temporally compressed representation of the input video generated by the progressive encoder 604. For example, one or more downstream applications or services can modify the temporally compressed representation of the input video generated by the progressive encoder 604. As a result, the progressive decoder 606 generates a reconstructed version of the input video (e.g., the input video intentionally modified by the content generated, embedded, or otherwise incorporated by the one or more downstream applications). In some embodiments, the progressive decoder 606 decompresses the temporally compressed representation of the input video, along with other content generated, embedded, or otherwise incorporated by the one or more downstream applications. For example, the progressive decoder 606 receives multiple compressed inputs. As a result, the progressive decoder 606 generates a reconstructed version of the input video (e.g., the input video intentionally modified by the content generated, embedded, or otherwise incorporated by the one or more downstream applications).

The progressive decoder 606 can include a sequence of decompression models that each gradually decompress a temporally compressed representation of an input video. For example, the progressive decoder 606 includes an upsampling manager (not shown) configured to perform a first temporal decompression of the temporally compressed input video at a first decompression ratio. The progressive decoder 606 also includes the trained base decoder 614 configured to perform a second temporal decompression using the first temporal decompression of the input video. The decompression performed by the trained base decoder 614 is at a second decompression ratio that is greater than the first compression ratio. As described herein, the trained base decoder 614 can be a component of a pretrained autoencoder that is fine-tuned. In operation, each model of the progressive decoder 606 generates a temporally decompressed representation of the temporally compressed representation of the input video. The subsequent decompression of the temporally compressed representation of the input video by each of the models of the progressive decoder 606 correspond to the gradual decompression by the progressive decoder 606.

As illustrated in FIG. 6, the system for progressive growing VAE 600 includes a neural network manager 608. Neural network manager 608 may host a plurality of neural networks or other machine learning models, such as base encoder 612, trained base encoder 614, and specialized compression manager 616.

The neural network manager 608 may include an execution environment, libraries, and/or any other data needed to execute the machine learning models. In some embodiments, the neural network manager 608 may be associated with dedicated software and/or hardware resources to execute the machine learning models. Although depicted in FIG. 6 as being hosted by a single neural network manager 608, in various embodiments the neural networks may be hosted in multiple neural network managers and/or as part of different components. For example, the base encoder 612, trained base encoder 614, and specialized compression manager 616 can be hosted by their own neural network manager, or other host environment, in which the respective neural networks execute, or the machine learning models may be spread across multiple neural network managers depending on, e.g., the resource requirements of each machine learning model, etc.

As illustrated in FIG. 6, the system for progressive growing VAE 600 also includes the storage manager 610. The storage manager 610 maintains data for the system for progressive growing VAE 600. The storage manager 610 can maintain data of any type, size, or kind as necessary to perform the functions of the progressive growing VAE 100 described in FIG. 1.

The storage manager 610, as shown in FIG. 6, includes hyperparameters 618. Hyperparameters include information associated with the base encoder 612, trained base decoder 614, and specialized compression manager 616 (e.g., weights, a number of neurons, a number of layers, etc.). As described with reference to FIG. 5, some hyperparameters 618 are frozen (e.g., the hyperparameters of the base encoder 612) while other hyperparameters 618 are updated during the end-to-end training of the progressive growing VAE 100 (e.g., the hyperparameters of the trained base decoder 614 and the hyperparameters of the specialized compression manager 616). In some embodiments, hyperparameters of the trained base decoder 614 are not updated during the end-to-end training of the progressive growing VAE and an appended set of hyperparameters 618 fine-tune an initialized base decoder such that the base decoder with the appended set of hyperparameters 618 becomes the trained base decoder 614.

As further illustrated in FIG. 6, the storage manager 610 also includes training data 620. Because of the self-supervised or semi-supervised nature of the autoencoder (e.g., the optimal or ideal output of the decoder is the input to the encoder), training data 620 can include input videos. As described herein, the input video can be a portion of an original video (e.g., a number of frames of the original video).

Each of the components 602-610 of the system for progressive growing VAE 600 and their corresponding elements (as shown in FIG. 6) may be in communication with one another using any suitable communication technologies. It will be recognized that although components 602-610 and their corresponding elements are shown to be separate in FIG. 6, any of components 602-610 and their corresponding elements may be combined into fewer components, such as into a single facility or module, divided into more components, or configured into different components as may serve a particular embodiment.

The components 602-610 and their corresponding elements can comprise software, hardware, or both. For example, the components 602-610 and their corresponding elements can comprise one or more instructions stored on a computer-readable storage medium and executable by processors of one or more computing devices. When executed by the one or more processors, the computer-executable instructions of the system for progressive growing VAE 600 can cause a client device and/or a server device to perform the methods described herein. Alternatively, the components 602-610 and their corresponding elements can comprise hardware, such as a special purpose processing device to perform a certain function or group of functions. Additionally, the components 602-610 and their corresponding elements can comprise a combination of computer-executable instructions and hardware.

Furthermore, the components 602-610 of the system for progressive growing VAE 600 may, for example, be implemented as one or more stand-alone applications, as one or more modules of an application, as one or more plug-ins, as one or more library functions or functions that may be called by other applications, and/or as a cloud-computing model. Thus, the components 602-610 of the system for progressive growing VAE 600 may be implemented as a stand-alone application, such as a desktop or mobile application. Furthermore, the components 602-610 of the system for progressive growing VAE 600 may be implemented as one or more web-based applications hosted on a remote server. Alternatively, or additionally, the components of the progressive growing VAE 600 may be implemented in a suite of mobile device applications or “apps.”

As shown, the system for progressive growing VAE 600 can be implemented as a single system. In other embodiments, the system for progressive growing VAE 600 can be implemented in whole, or in part, across multiple systems. For example, one or more functions of the progressive growing VAE 600 can be performed by one or more servers, and one or more functions of the system for progressive growing VAE 600 can be performed by one or more client devices. The one or more servers and/or one or more client devices may generate, store, receive, and transmit any type of data used by the system for progressive growing VAE 600, as described herein.

In one implementation, the one or more client devices can include or implement at least a portion of the system for progressive growing VAE 600. In other implementations, the one or more servers can include or implement at least a portion of the system for progressive growing VAE 600. For instance, the system for progressive growing VAE 600 can include an application running on the one or more servers or a portion of the system for progressive growing VAE 600 can be downloaded from the one or more servers. Additionally or alternatively, the system for progressive growing VAE 600 can include a web hosting application that allows the client device(s) to interact with content hosted at the one or more server(s).

For example, upon a client device accessing a webpage or other web application hosted at the one or more servers, in one or more embodiments, the one or more servers can provide access to a user interface displayed at a client device. A user can request one or more actions of an application or a service using an input video. For example, a user can request storage of a selected video. Additionally or alternatively, a user can request generation of supplemental video content associated with a user-uploaded video. The client device can provide the input video to one or more servers, which can automatically perform the methods and processes described herein to generate a temporally compressed input video using the progressive encoder of the progressive growing VAE. Depending on the user request, one or more actions can be performed using the temporally compressed video by the application or service. For example, an application can generate video content that extends the duration of the input video. The temporally compressed representation of the input video can be modified based on the application(s) or service(s) that receive the temporally compressed representation of the input video. In some embodiments, the application(s) or service(s) that receive the temporally compressed representation of the input video generate representations of data distinct from the temporally compressed representation of the input video. For example, content added by a generative application can be stored in a vector separate from the vector including the latent space representation of the input video (e.g., the temporally compressed representation of the input video). The temporally compressed representation of the input video (and any one or more additional data that is generated using the temporally compressed representation of the input video) is passed to the progressive decoder of the progressive growing VAE for decompression and reconstruction. The one or more servers can then provide access to the user interface displayed at the client device to display the reconstructed input video and any modifications of the reconstruction input video (if any, depending on the user request).

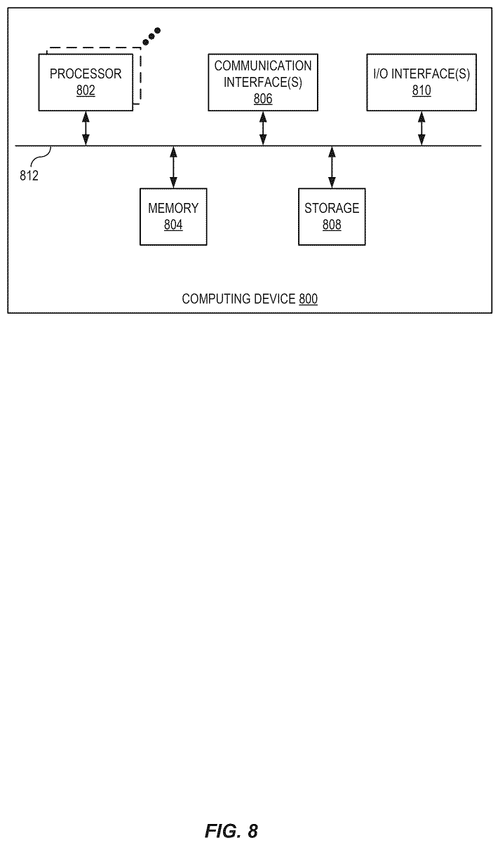

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 8. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 8.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 8.

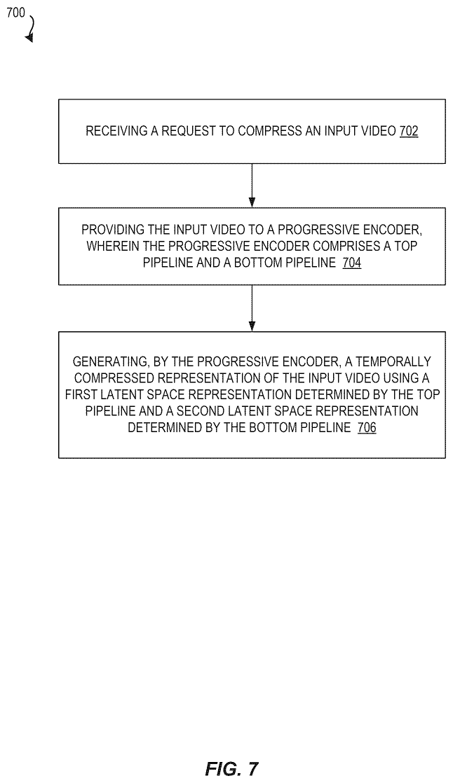

FIGS. 1-6, the corresponding text, and the examples, provide a number of different systems and devices that allows a progressive growing VAE to boost temporal compression. In addition to the foregoing, embodiments can also be described in terms of flowcharts comprising acts and steps in a method for accomplishing a particular result. For example, FIG. 7 illustrates a flowchart of an exemplary method in accordance with one or more embodiments. The method described in relation to FIG. 7 may be performed with fewer or more steps/acts or the steps/acts may be performed in differing orders. Additionally, the steps/acts described herein may be repeated or performed in parallel with one another or in parallel with different instances of the same or similar steps/acts.

FIG. 7 illustrates a flowchart 700 of a series of acts in a method of using a progressive growing variational autoencoder to boost temporal compression in accordance with one or more embodiments. In one or more embodiments, the method 700 is performed in a digital medium environment that includes the variational VAE 600. The method 700 is intended to be illustrative of one or more methods in accordance with the present disclosure and is not intended to limit potential embodiments. Alternative embodiments can include additional, fewer, or different steps than those articulated in FIG. 7.

As illustrated in FIG. 7, the method 700 includes an act 702 of receiving a request to compress an input video. In some embodiments, the request to compress the input video is determined using a user at a user interface displayed on a client device. In some embodiments, the request to compress the input video is received from one or more upstream applications or services. For example, the operation of one or more upstream applications or services can be improved using a temporally compressed representation of an input video as opposed to an input video. For instance, computing resources such as power, memory, and bandwidth can be conserved when executing an application on a temporally compressed representation of the input video as opposed to the input video, by virtue of spending less power, memory and bandwidth on a larger video (e.g., the input video) as compared to the power, memory and bandwidth required to process or operate on the temporary compressed representation of the input video.

As illustrated in FIG. 7, the method 700 includes an act 704 of providing the input video to a progressive encoder. The progressive encoder includes a top pipeline and a bottom pipeline. The top pipeline includes a number of compression models each configured to generate a temporal compression of the input video. As a result of the gradual compression of each of the models of the top pipeline, the top pipeline generates a first pass of temporal compression of the input video. The first pass of temporal compression of the input video corresponds to a first latent space representation determined by the top pipeline. A latent space representation is a numerical representation of the temporally compressed input video. The bottom pipeline includes a number of compression models each configured to generate a temporal compression of the input video. As a result of the gradual compression of each of the models of the bottom pipeline, the bottom pipeline generates a second pass of temporal compression of the input video. The second pass of temporal compression of the input video corresponds to a second latent space representation determined by the bottom pipeline.

As illustrated in FIG. 7, the method 700 includes an act 706 of generating, by the progressive encoder, a temporally compressed representation of the input video using a first latent space representation determined by the top pipeline and a second latent space representation determined by the bottom pipeline.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 that may be configured to perform one or more of the processes described above. One will appreciate that one or more computing devices such as the computing device 800 may implement the progressive growing VAE 100. As shown by FIG. 8, the computing device can comprise a processor 802, memory 804, one or more communication interfaces 806, a storage device 808, and one or more I/O devices/interfaces 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 808 and decode and execute them. In various embodiments, the processor(s) 802 may include one or more central processing units (CPUs), graphics processing units (GPUs), field programmable gate arrays (FPGAs), systems on chip (SoC), or other processor(s) or combinations of processors.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 804 may be internal or distributed memory.

The computing device 800 can further include one or more communication interfaces 806. A communication interface 806 can include hardware, software, or both. The communication interface 806 can provide one or more interfaces for communication (such as, for example, packet-based communication) between the computing device and one or more other computing devices 800 or one or more networks. As an example and not by way of limitation, communication interface 806 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can comprise hardware, software, or both that couples components of computing device 800 to each other.

The computing device 800 includes a storage device 808 includes storage for storing data or instructions. As an example, and not by way of limitation, storage device 808 can comprise a non-transitory storage medium described above. The storage device 808 may include a hard disk drive (HDD), flash memory, a Universal Serial Bus (USB) drive or a combination of these or other storage devices. The computing device 800 also includes one or more input or output (“I/O”) devices/interfaces 810, which are provided to allow a user to provide input to (such as user strokes), receive output from, and otherwise transfer data to and from the computing device 800. These I/O devices/interfaces 810 may include a mouse, keypad or a keyboard, a touch screen, camera, optical scanner, network interface, modem, other known I/O devices or a combination of such I/O devices/interfaces 810. The touch screen may be activated with a stylus or a finger.

The I/O devices/interfaces 810 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 810 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a request to compress an input video;
providing the input video to a progressive encoder, wherein the progressive encoder comprises a top pipeline and a bottom pipeline; and
generating, by the progressive encoder, a temporally compressed representation of the input video using a first latent space representation determined by the top pipeline and a second latent space representation determined by the bottom pipeline.

2. The method of claim 1, wherein the top pipeline performs a first pass of temporal compression, the method further comprising:
generating a first temporally compressed representation of input video using a first model of the top pipeline and the input video; and
generating a second temporally compressed representation of the input video using a second model of the top pipeline and the first temporally compressed representation of the input video, wherein the second temporally compressed representation of the input video is the first latent space representation.

3. The method of claim 2, wherein the bottom pipeline performs a second pass of temporal compression, the method further comprising:
generating a third temporally compressed representation of input video using the second model of the top pipeline and the input video; and
generating a fourth temporally compressed representation of the input video using a first model of the bottom pipeline and the third temporally compressed representation of the input video, wherein the fourth temporally compressed representation of the input video is the second latent space representation.

4. The method of claim 1, further comprising:
receiving a request to decompress the temporally compressed representation of the input video; and
generating a reconstructed input video using a progressive decoder and the temporally compressed representation of the input video, wherein the progressive decoder is trained using end-to-end training with the progressive encoder.

5. The method of claim 4, wherein the progressive encoder and the progressive decoder are trained using end-to-end training, the method further comprising:
training a decoder of the progressive decoder using a loss based on the reconstructed input video and the input video;
training a model of the bottom pipeline of the progressive encoder using the loss; and
skipping training of the top pipeline of the progressive encoder using the loss.

6. The method of claim 4, further comprising:
generating a temporally decompressed representation of the temporally compressed representation of the input video using a first model of the progressive decoder; and
generating the reconstructed input video using a second model of the progressive decoder and the temporally decompressed representation of the temporally compressed representation of the input video.

7. The method of claim 1, further comprising:
generating, by a generative model, a representation of a modified input video using the temporally compressed representation of the input video; and
generating, by a progressive decoder, the modified input video using the representation of the modified input video, wherein the progressive decoder is trained using end-to-end training with the progressive encoder.

8. A non-transitory computer-readable medium storing executable instructions, which when executed by a processing device, cause the processing device to perform operations comprising:
receiving a request to compress an input video;
providing the input video to a progressive encoder, wherein the progressive encoder comprises a top pipeline and a bottom pipeline; and
generating, by the progressive encoder, a temporally compressed representation of the input video using a first latent space representation determined by the top pipeline and a second latent space representation determined by the bottom pipeline.

9. The non-transitory computer-readable medium of claim 8, wherein the top pipeline performs a first pass of temporal compression, and the non-transitory computer-readable medium stores instructions that further cause the processing device to perform operations comprising:
generating a first temporally compressed representation of input video using a first model of the top pipeline and the input video; and
generating a second temporally compressed representation of the input video using a second model of the top pipeline and the first temporally compressed representation of the input video, wherein the second temporally compressed representation of the input video is the first latent space representation.

10. The non-transitory computer-readable medium of claim 9, wherein the bottom pipeline performs a second pass of temporal compression, and the non-transitory computer-readable medium stores instructions that further cause the processing device to perform operations comprising:
generating a third temporally compressed representation of input video using the second model of the top pipeline and the input video; and
generating a fourth temporally compressed representation of the input video using a first model of the bottom pipeline and the third temporally compressed representation of the input video, wherein the fourth temporally compressed representation of the input video is the second latent space representation.

11. The non-transitory computer-readable medium of claim 8, storing instructions that further cause the processing device to perform operations comprising:
receiving a request to decompress the temporally compressed representation of the input video; and
generating a reconstructed input video using a progressive decoder and the temporally compressed representation of the input video, wherein the progressive decoder is trained using end-to-end training with the progressive encoder.

12. The non-transitory computer-readable medium of claim 11, wherein the progressive encoder and the progressive decoder are trained using end-to-end training, and the non-transitory computer-readable medium stores instructions that further cause the processing device to perform operations comprising:
training a decoder of the progressive decoder using a loss based on the reconstructed input video and the input video;
training a model of the bottom pipeline of the progressive encoder using the loss; and
skipping training of the top pipeline of the progressive encoder using the loss.

13. The non-transitory computer-readable medium of claim 11, storing instructions that further cause the processing device to perform operations comprising:
generating a temporally decompressed representation of the temporally compressed representation of the input video using a first model of the progressive decoder; and
generating the reconstructed input video using a second model of the progressive decoder and the temporally decompressed representation of the temporally compressed representation of the input video.

14. The non-transitory computer-readable medium of claim 8, storing instructions that further cause the processing device to perform operations comprising:
generating, by a generative model, a representation of a modified input video using the temporally compressed representation of the input video; and
generating, by a progressive decoder, the modified input video using the representation of the modified input video, wherein the progressive decoder is trained using end-to-end training with the progressive encoder.

15. A system comprising:
a memory component; and
a processing device coupled to the memory component, the processing device to perform operations comprising:
receiving a request to compress an input video;
providing the input video to a progressive encoder, wherein the progressive encoder comprises an encoder configured to compress the input video using a first compression ratio; and
generating, by the progressive encoder, a temporally compressed representation of the input video using a second compression ratio, wherein the second compression ratio is higher than the first compression ratio.

16. The system of claim 15, wherein the progressive encoder comprises a top pipeline configured to perform a first pass of temporal compression using the encoder.

17. The system of claim 15, wherein the progressive encoder comprises a bottom pipeline configured to perform a second pass of temporal compression using the encoder.

18. The system of claim 15, wherein the progressive encoder is used in an autoencoder, and wherein the autoencoder is trained end-to-end.

19. The system of claim 18, wherein the processing device performs further operations comprising:
propagating a loss determined during the end-to-end training to a bottom pipeline of the progressive encoder, wherein the loss is based on a first pass of temporal compression determined by a top pipeline of the progressive encoder.

20. The system of claim 19, wherein the processing device performs further operations comprising:
generating a reconstructed input video using a progressive decoder and the temporally compressed representation of the input video; and
determining the loss using the reconstructed input video and the input video.
